(19) United States
(12) Patent Application Publication
(10) Pub. No.: US 2005/0257699 A1
(43) Pub. Date: Nov. 24, 2005

(54) Press for draining canned goods

(76) Inventor: Gary Wimberly, Bend, OR (US)

Correspondence Address: GLENN C. BROWN, PC, 777 NW WALL STREET, SUITE 308, BEND, OR, 97701, US

(21) Appl. No.: 10/931,157

(22) Filed: Aug. 30, 2004

Related U.S. Application Data
(60) Provisional application No. 60/573,463, filed on May 20, 2004.

(51) Int. Cl. B30B 9/06

(52) U.S. Cl. 100/234

(57) ABSTRACT

A press for draining liquids from canned goods including a pair of pivoting arms. A press plate is attached to each pivoting arm. The press is operable to squeeze liquid from canned goods such as canned meats and canned vegetables.

### CROSS-REFERENCE TO RELATED APPLICATION

This application is a continuation-in-part of U.S. provisional patent application Ser. No. 60/573,463, filed on May 20, 2004. The priority of the prior application is expressly claimed and its disclosure is hereby incorporated by reference in its entirety.

### BACKGROUND OF THE INVENTION

1. Technical Field

This invention relates to cooking and food preparation utensils, and in particular to a new and improved utensil for draining liquids from canned goods.

2. Field of the Invention

Many food products are packaged and sold in cans, including meats, fish, fruit, and vegetables. Many of the foods packaged and sold in cans require that the liquid in which the product is packaged be drained as a first step in preparing the food for consumption. This usually requires that the can be opened at one or both ends, and the liquid decanted from the open end of the can.

Most people find this to be a messy and cumbersome process, particularly with foods such as seafood packed in oil or water. The handling and decanting of the can often requires one to handle a lid with sharp edges, and often results in smelly liquids being spilled onto one's hands or clothes.

### BRIEF SUMMARY OF THE INVENTION

This invention addresses and solves the problems encountered in the handling of canned goods by providing a utensil that enables one to simultaneously hold, decant and even press packing liquid from foods.

### BRIEF DESCRIPTION OF THE DRAWINGS

The nature, principle and utility of the present invention will be clearly understood from the following detailed description when read in conjunction with the accompanying drawings, wherein:

FIG. 1 is a side view of the utensil of the present invention.

FIG. 2 is a side view of the utensil of the present invention being used to open a container.

The drawings are for illustrative purposes only and are not drawn to scale. In the drawings, the same numbers are used for the same part or portion throughout the drawings.

### DETAILED DESCRIPTION OF THE INVENTION

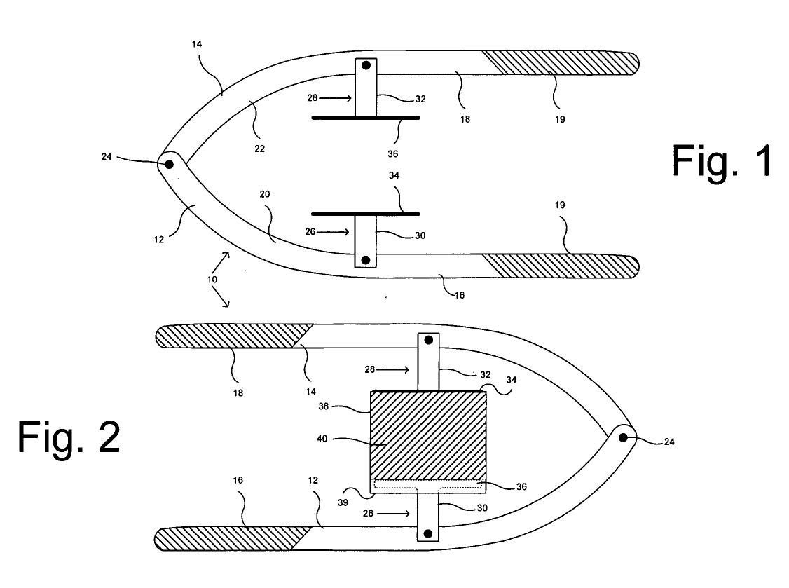

Referring to FIG. 1, a utensil according to the present invention is shown at 10. Utensil 10 includes first and second hinged arms 12 and 14. Arms 12 and 14 include respective handle portions 16 and 18 and curved portions 20 and 22. Handle portions 16 and 18 are optionally fitted with a cushioned or non-slip material 19. Curved portions 20 and 22 are pivotably connected by pin 24. Attached to a central portion of each of arms 12 and 14 are pivoting press members 26 and 28. Press members 26 and 28 include respective pivoting arms 30 and 32. Each of pivoting arms 30 and 32 includes a press plate (34 and 36). Press plate is sized to fit inside a typical can, although the invention is not limited to any particular size.

Referring now to FIG. 2, utensil 10 is used by first opening the container 38, whether a can or jar, spreading arms 12 and 14, and then placing one end of container 38 against press plate 34. Press plate 36 is then inserted into the open end 39 of container 10. Handles 16 and 18 are then squeezed together, compressing the contents 40 of container 38 and expelling free liquid from the contents. During the compressing of contents 40 container 38 can be tilted to decant the liquid from the container 38 as desired.

A number of variations to the preferred embodiment are possible. The utensil can be made from any suitable metallic or polymeric material. Press plates 34 and 36 can be of any size, and in one embodiment are removable and replaceable with a plate of a desired size. In another embodiment spreading arms 12 and 14 and press plates 34 and 36 can be dissembled for thorough cleaning as needed.

Those skilled in the art will recognize that these and other modifications could be made to the preferred embodiment without departing from the scope of the invention.

1. A press for draining canned goods comprising:
first and second elongate arms pivotably attached at their respective first ends;
a first pressing member pivotably attached to the first arm;
a second pressing member pivotably attached to the second arm; and,
the press operable to place the first and second pressing members on opposite ends of a can and to urge the pressing members toward one another, thereby compressing can contents to remove liquid therefrom.

2. A press according to claim 1 further comprising each arm having a second respective end including a handle.

3. A press according to claim 1 further comprising the first and second pressing members being removably mounted to the respective first and second handles.

4. A press according to claim 4 further comprising the first and second pressing members being pivotable into a substantially parallel position.

5. A press according to claim 1 further further comprising the first and second pressing members being removabley attached to the respective first and second elongate arms.
